(19) United States
(12) Patent Application Publication
(10) Pub. No.: US 2006/0068268 A1
(43) Pub. Date: Mar. 30, 2006

(54) Membrane and membrane electrode assembly with adhesion promotion layer

(76) Inventor: David Olmeijer, San Francisco, CA (US)

Correspondence Address: Richard F. Trecartin;Dorsey & Whitney LLP, Intellectual Property Department, 555 California Street, 10th Floor, San Francisco, CA, 94104-1513, US

(21) Appl. No.: 11/222,643

(22) Filed: Sep. 8, 2005

Related U.S. Application Data
(60) Provisional application No. 60/608,399, filed on Sep. 8, 2004.

(51) Int. Cl. H01M 4/86; H01M 4/96; H01M 4/88; B05D 5/12; H01M 2/08

(52) U.S. Cl. 429/42; 429/44; 427/115; 502/101; 429/36

(57) ABSTRACT

This application relates to membrane electrode assemblies (MEA's) that contain an ion conducting adhesion promotion layer to promote structural stability at the interface of the PEM and catalyst layer within the MEA.

This application claims the benefit under 35 U.S.C. § 119(e) of U.S. Provisional Patent Application No. 60/608,399, filed on Sep. 8, 2004 and is incorporated by reference herein.

### TECHNICAL FIELD

This application relates to polymer electrolyte membranes (PEMs) which utilize an adhesion promotion layer containing an ion conducting adhesive composition to promote structural stability at the interface of the PEM and catalyst layer within a membrane electrode assembly.

### BACKGROUND OF THE INVENTION

A significant problem with fuel cells that utilize polymer electrolyte membranes (PEMs) is the instability of the interface between the surface of the PEM and the catalyst layer. Failure to form and maintain this interface can result in separation of the catalyst layer from the PEM and an increase in the internal resistance of the fuel cell.

Nafion® is a perfluorinated ion conducting polymer that has been used to make PEMs. Nafion® has also been the ionomer of choice when preparing catalyst inks used to form a catalyst layer on the PEM. Nafion® has been used as the PEM as well as in the catalyst layer. However, Nafion® membranes have limited utility when used in a direct methanol fuel cell or at elevated temperatures.

To overcome Nafion's® limitations, new ion conducting polymers have been developed. However, the interface between PEMs made from such polymers and catalyst layers made of Nafion® is less than satisfactory. This is primarily due to the difference in physical and chemical properties between the PEM polymer and the catalyst polymer.

### SUMMARY OF THE INVENTION

The invention is directed to the use of an ion conducting adhesive composition to enhance the physical and electrical contact between a polymer electrolyte membrane (PEM) and catalyst layer.

The invention includes a membrane electrode assembly (MEA) comprising a PEM made from a first ion conducting polymer. An adhesion promotion layer comprising an ion conducting adhesive composition (sometimes referred to as the adhesive composition) is in contact with a first surface of the PEM and a first surface of the catalyst layer. The catalyst layer includes a second ion conducting polymer and catalyst. A gas diffusion layer (GDL) may interface with the catalyst layer.

The MEA may also include a second adhesive layer in contact with the second surface of the PEM and a second catalyst layer. In some embodiments, the second catalyst layer is also in contact with a GDL layer.

In general, the ion conducting adhesive composition comprises at least the ion conducting polymer of the PEM or the ion conducting polymer of the catalyst layer. In some embodiments, ion conducting polymers from the PEM and the catalyst layer are used to form the ion conducting adhesive composition.

In an alternate embodiment, solid particles such as inorganic particles are dispersed in the ion conducting polymer to form the adhesive composition. Such particles have an average diameter of between 20 nm and 2,000 nm. They can be graphitic or amorphous carbon powder or oxides of silicon, titanium and zirconium.

In still another embodiment, the adhesive composition comprises an ion conducting polymer in combination with a non-ionomeric polymer. In general, the non-ionomeric polymer has a Tm or Tg which is less than 200° C. In a particularly preferred embodiment, the non-ionomeric polymer comprises a copolymer of vinylidenefluoride and hexafluoropropylene.

In still a further embodiment, the adhesive layer comprises an ion conducting adhesive composition comprising at least one of the first or second ion conducting polymers or both wherein pores are dispersed within the polymer(s).

The adhesion promotion layer is generally between 200 nm and 5,000 nm thick.

The invention also includes a method for making a membrane electrode assembly (“MEA”). An ion conducting adhesive composition is applied to at least one surface of a PEM and/or the surface of a catalyst layer. The PEM and the catalyst layer are placed in close proximity so as to form an adhesion promotion layer between the PEM and catalyst layer of the electrode to form a partial MEA. The catalyst layer may act as an electrode or be part of an electrode.

In most embodiments, the second surface of the PEM and/or the surface of a second catalyst layer is coated with a ion conducting adhesive composition. The PEM and the second electrode are then brought into close proximity so as to form an adhesion promotion layer between the PEM and catalyst layer of the second electrode. The second catalyst layer may also act as an electrode or be part of an electrode.

The MEA is then annealed at a temperature between 120° and 170° centigrade and at a pressure between 25 and 120 kilograms per square centimeter.

In general, the adhesion of the electrode to the PEM via the adhesion promotion layer is greater than the adhesion of the electrode to the PEM without an adhesion promotion layer.

### DETAILED DESCRIPTION OF THE INVENTION

The invention utilizes an ion conductive adhesive composition to form an adhesion promotion layer between the catalyst layer and PEM of an MEA.

The PEMs used in making MEAs or adhesive coated PEMs may be any of a wide variety of membranes known in the art. Particularly preferred PEMs include those disclosed in U.S. patent applications Ser. No. 09/872,770, filed Jun. 1, 2001, entitled “Polymer Composition”; Ser. No. 10/351,257, filed Jan. 23, 2003, entitled “Acid Base Proton Conducting Polymer Blend Membrane”; Ser. No. 10/438,186, filed May 13, 2003, entitled “Sulfonated Copolymer”; Ser. No. 10/449,299, filed Feb. 20, 2003, entitled “Ion Conductive Copolymer”; and 60/520,266, filed Nov. 13, 2003 entitled “Ion Conductive Copolymers Containing First and Second Hydrophobic Oligomers,” each of which are expressly incorporated herein by reference. The process may also be practiced on other membranes commonly known to those skilled in the art. For example, sulfonated trifluorostyrenes (U.S. Pat. No. 5,773,480), acid-base polymers, (U.S. Pat. No. 6,300,381), poly arylene ether sulfones (U.S. patent application No. US2002/0091225A1); graft polystyrene (Macromolecules 35:1348 (2002)); and polyimides (U.S. Pat. No. 6,586,561 and J. Membr. Sci. 160:127 (1999)) can be used to make polymer electrolyte membranes which find use in the present invention. Other PEMs include those disclosed in Japanese Patent Application Nos. JP2003147076 and JP2003055457. In general, the PEM's used in making CCM's membranes are made of sulfonated poly(arylether ketone) or perfluorosulfonic acid ionomers.

The term “ion conducting adhesive composition” refers to a composition comprising a first ion conducting polymer in combination with (1) a second ion conducting polymer; (2) inorganic particles dispersed within the ion conducting polymer; and/or (3) a non-ionomeric polymer. The ion conducting polymer can also contain pores to facilitate adhesion as described herein.

Ion conducting adhesive compositions are generally used when the PEM and catalyst layer contain different ion conducting polymers. In a preferred embodiment, first and second ion conducting polymers are used to make the adhesive polymer composition. These first and second ion conducting polymers preferably correspond to the ion conducting polymers in the PEM and catalyst layer, respectively. The ion conducting adhesive polymer accordingly has an affinity for both the PEM and the catalyst layer that allows the combination to be used as an adhesive. For example, if the PEM comprises an ion conducting polymer with a poly(arylether ketone) backbone (PEEK) and the catalyst layer comprises Nafion® as an ionomer, Nafion® and sulfonated PEEK can be combined to form an ion conductive adhesive composition.

However, the first and/or second ion conducting polymers of the adhesive composition need not be the same as the ion conducting polymers of the PEM and catalyst layer. In such cases, the first and second ion conducting polymer are preferably closely related to the ion conducting polymers of the PEM and/or catalyst layer. For example, a first ion conducting polymer is chosen based on the ability to adhere to the surface of the PEM. The second ion conducting polymer is chosen based on its ability to adhere to the catalyst layer.

In another embodiment, the above ion conducting polymers are used in combination with inorganic particles, non-ionomeric polymers and/or pores dispersed therein. When the PEM is not made from Nafion® and the catalyst layer is made from Nafion®, Nafion® may also be used as the ion conducting polymer in an ion conductive adhesive composition, i.e., in combination with inorganic particles, non-ionomeric polymers or pores.

When the ion conducting polymer is mixed with inorganic particles, the non-ionic particle selected should have an average diameter of between 20 nm and 2000 nm. Inorganic particles which may be used include graphitic or amorphous carbon powder or oxides of silicon, titanium and zirconium. The ion-conducting polymer should comprise a sufficient fraction of the mixture to allow proton conductivity through the. The portion of the composition comprising the ion-containing polymer should preferably be 10-95%, more preferably 25-90% and most preferably 50-80%.

When the ion conducting polymer is mixed with a non-ionic polymer, the non-ionic polymer selected should have a melting or glass transition temperature of less than 200C. Non-ionic polymers which may be used include poly(vinylidene fluoride), copolymers of vinylidene fluoride and hexafluoropropylene, poly(vinyl fluoride), polyethylene, polypropylene, polybutadiene and copolymers of butadiene, acrylonitrile and/or styrene. In a preferred embodiment, the non-ionic polymer used is a copolymer of vinylidene fluoride and hexafluoropropylene. The ion-conducting polymer should comprise a sufficient fraction of the mixture to allow proton conductivity through the layer without hampering the ability of the non-ion conducting polymer to promote adhesion to the catalyst layer. The portion of the composition comprising the ion-containing polymer should preferably be 10-95%, more preferably 25-90% and most preferably 50-80%.

Adhesive compositions containing pores are made by combining an ion conducting polymer with a porogen. This mixture is applied to the surface of a PEM and/or a surface of an electrode (i.e., the surface of the catalyst layer) followed by washing with a solvent that is capable of dissolving the porogen but not the ion conducting polymer. After drying, the adhesive coated PEM and/or adhesive coated electrode are placed in proximity to each other to form an adhesive layer between the surface of the catalyst layer and the surface of the PEM. The ion conducting polymer of the catalyst layer preferably fills the pores of the adhesive composition. The ion conducting polymer of the PEM may also enter the pores of the adhesive layer depending upon its ability to flow into the pores under the conditions for forming MEA.

Any of the ion conducting polymers used to make a PEM may also be used as ionomers in the catalyst layer. However, a preferred ionomer for use in forming the catalyst layer is Nafion®.

The electrodes used to form the MEAs of the invention preferably comprise a catalyst layer and a gas diffusion layer. The catalyst layer comprises a catalyst (e.g., platinum or platinum/ruthenium particles or catalyst particles supported on carbon particle) and an ionomer such as Nafion®. The gas diffusion layer (GDL) may comprise carbon paper or cloth, e.g., Toray paper and the like. First, electrodes comprising the GDL and first catalyst layer can be used in combination with the ion conductive adhesive composition and the first surface of the PEM to form the MEA.

The MEA may further comprise a second adhesion promotion layer between a second surface of the PEM and a second catalyst layer. The ion conductive adhesive composition may comprise a third ion conducting polymer in combination with (1) a fourth ion conducting polymer; (2) inorganic particles dispersed within the ion conducting polymer; and/or (3) a non-ionomeric polymer. It may also contain pores formed within the ion conducting polymer. The third and fourth ion conducting polymers may be the same as the first and second ion conducting polymers used above to form the first adhesive layer or may be different. If the catalyst layers are made from the same ion conducting polymer, it is preferred that the third and fourth ion conducting polymers correspond to the first and second ion conducting polymers.

In an alternate embodiment, a gas diffusion layer may be laid down on a decal. A catalyst may then be layered on the exposed surface of the GDL. The decal containing the electrode can be used according to the disclosure of the invention to form the MEA containing an ion conductive adhesive layer between the PEM and the catalyst layer present on the decal.

### EXAMPLES

### Example 1

A 5% solution of Nafion® PFSA ionomer in DMAc solvent (9.5 g) is added to a vial which contains graphitized carbon particles (0.158 g) such that the weight ratio of solid Nafion® to solid graphitized carbon is 3:1. Additional DMAc solvent (3.0 g) is added such that the final % solids of the slurry is 5% by weight. The slurry is sonicated with a probe sonicator for 10 minutes to form ion conducting adhesive. A polymer electrolyte membrane based on a sulfonated poly(arylene ether ketone) is dried in a 100° C. oven for 15 minutes. The ion conducting adhesive is applied to each side of this membrane slurry using a #6 rod-coater. The adhesive is dried under forced air at room temperature and then in an oven at 100° C. for 45 minutes. The resultant adhesive-coated membrane is annealed in a hotpress at 140° C. for 2 minutes under about 10 kg/cm2.

### Example 2

A 5% solution of Nafion® PFSA ionomer in DMAc solvent (2.0 g) is mixed with a 5% solution of a sulfonated poly(arylene ether ketone) in DMAc (2.0 g). The mixture is agitated for a few moments. The mixture is sonicated with a probe sonicator for 10 minutes to form an ion conducting adhesive composition. A polymer electrolyte membrane based on a sulfonated poly(arylene ether ketone) is dried in a 100° C. oven for 15 minutes. The ion conducting composition is applied to each side of this membrane using a #6 rod-coater. The adhesive is dried under forced air at room temperature and then in an oven at 100° C. for 45 minutes. The resultant adhesive-coated membrane is annealed in a hotpress at 140° C. for 2 minutes under about 10 kg/cm2.

### Example 3

A 5% solution of a sulfonated poly(arylene ether ketone) in DMAc (2.0 g) is mixed with a 5% solution of poly(vinylidene fluoride-co-hexafluoropropylene) in DMAc (1.0 g). The mixture is agitated for a few moments to form an ion conducting adhesive composition. The mixture is sonicated with a probe sonicator for 10 minutes. A polymer electrolyte membrane based on a sulfonated poly(arylene ether ketone) is dried in a 100° C. oven for 15 minutes. The ion conducting adhesive composition is applied to each side of this membrane using a #6 rod-coater. The adhesive is dried under forced air at room temperature and then in an oven at 100° C. for 45 minutes.

### Example 4

The surface coated membrane from Example 1, 2 or 3 is soaked in water at 60° C. for 16 hours. It is removed from the water and is blotted dry. An anode (PtRu electrocatalyst+Nafion® ionomer on a GDL carbon paper) and a cathode (Pt electro catalyst+Nafion® ionomer on a GDL carbon paper) are placed on either side of the membrane. The Anode/Membrane/Cathode laminate is pressed at 150° C. for 3 minutes at 80 kg/cm2.

What is claimed is:

1. A membrane electrode assembly (MEA) comprising:
a. a polymer electrolyte membrane (PEM) comprising a first ion conducting polymer and having first and second surfaces;
b. a first catalyst layer comprising a second ion conducting polymer and a catalyst, wherein said catalyst layer has a first surface, and
c. an adhesion promotion layer in contact with said first surface of said PEM and said first surface of said catalyst, wherein said adhesion promotion layer comprises an ion conducting adhesive composition.

2. The MEA of claim 1 wherein said catalyst layer acts as an electrode.

3. The MEA of claim 1 wherein said ion conducting adhesive composition comprises at least one of said first or said second ion conducting polymers.

4. The MEA of claim 3 wherein said adhesive composition further comprises inorganic particles dispersed in said first or said second ion conducting polymer.

5. The MEA of claim 4 wherein said inorganic particles are selected from the group consisting of graphitic and amorphous carbon powder, and oxides of silicon, titanium and zirconium.

6. The MEA of claim 4 wherein said inorganic particles have an average diameter between 20 nm and 2000 nm.

7. The MEA of claim 1 wherein said ion conducting adhesive composition comprises two or more ion conducting polymers.

8. The MEA of claim 7 wherein at least one of said ion conducting polymers comprises said first or said second ion conducting polymers.

9. The MEA of claim 7 wherein said ion conducting polymers comprises said first and said second ion conducting polymers.

10. The MEA of claim 1 wherein said adhesive composition further comprises a non-ionic polymer having a Tm or Tg less than 200° C.

11. The MEA of claim 1 wherein said adhesive composition comprises pores contained within said adhesion promotion layer.

12. The MEA of claim 1 wherein said adhesion promotion layer has a thickness between 200 nm and 5000 nm.

13. The MEA of claim 1 wherein the adhesion of said catalyst layer to said PEM via said adhesion promotion layer is greater that the adhesion of said electrode to said PEM without said adhesion promotion layer.

14. A method for making a membrane electrode assembly (MEA) comprising:
a. providing a polymer electrolyte membrane (PEM) comprising a first ion conducting polymer and having first and second surfaces and a first catalyst layer having a first surface and comprising a second ion conducting polymer;
b. applying an ion conducting adhesive composition on at least said first surface of said PEM or said first surface of said catalyst layer; and
c. positioning said PEM and said catalyst layer in close proximity so as to form an adhesion promotion layer between said first surface of said PEM and said first surface of said catalyst layer to form an MEA.

15. The method of claim 14 wherein said catalyst layer acts as an electrode.

16. The method of claim 14 further comprising:
a. providing a second catalyst layer comprising a third ion conducting polymer and a catalyst, wherein said catalyst layer comprises a first surface;
b. applying an ion conducting adhesive composition on at least said second surface of said PEM or said first surface of said second catalyst layer; and
c. positioning said PEM and said second catalyst in close proximity so as to form an adhesion promotion layer between said second surface of said PEM and said first surface of said second catalyst layer to form an MEA.

17. The method of claim 14 wherein said MEA is annealed at a temperature between 120 and 170° C. and a pressure between 25 and 120 kg/cm2.

18. The method of claim 14 wherein said ion conducting adhesive composition comprises at least one of said first or said second ion conducting polymers.

19. The method of claim 18 wherein said ion conducting adhesive composition further comprises inorganic particles dispersed in said ion conducting polymer.

20. The method of claim 19 wherein said inorganic particles are selected from the group consisting of graphitic or amorphous carbon powder and oxides of silicon, titanium and zirconium.

21. The method of claim 14 wherein said ion conducting adhesive composition comprises two or more ion conducting polymers.

22. The method of claim 21 wherein at least one of said ion conducting adhesive composition comprises said first or said second ion conducting polymers.

23. The method of claim 14 wherein said ion conducting adhesive composition further comprises a non-ionic polymer having a Tm or Tg less than 200° C.

24. The method of claim 14 wherein said ion conducting adhesive composition further comprises a porogen.

25. The method of claim 14 wherein said adhesion promotion layer has a thickness between 200 nm and 5000 nm.

26. The method of claim 14 wherein the adhesion of said first or said second electrode to said PEM via said adhesion promotion layer is greater that the adhesion of said first or second electrode to said PEM without said adhesion promotion layer.

27. A composition comprising a PEM and an adhesion promotion layer comprising an ion conductive adhesive composition on at least one of the surfaces of said PEM.

28. The composition of claim 27 wherein said ion conducting adhesive composition comprises at least one of said first or said second ion conducting polymers.

29. The composition of claim 28 wherein said adhesive composition further comprises inorganic particles dispersed in said ion conducting polymer.

30. The composition of claim 29 wherein said inorganic particles are selected from the group consisting of graphitic and amorphous carbon powder, and oxides of silicon, titanium and zirconium.

31. The composition of claim 27 wherein said adhesive composition comprises two or more ion conducting polymers.

32. The composition of claim 31 wherein at least one of said ion conducting adhesive composition comprises said first or said second ion conducting polymers.

33. The composition of claim 29 wherein said ion conducting adhesive composition comprises said first and said second ion conducting polymers.

34. The composition of claim 27 wherein said adhesive composition further comprises a non-ionic polymer having a Tm or Tg less than 200° C.

35. The composition of claim 27 wherein said adhesive composition comprises pores contained within at least one of said first or said second ion conducting polymers.

36. The composition of claim 27 wherein said adhesion promotion layer has a thickness between 200 nm and 5000 nm.

37. A fuel cell comprising the MEA of claim 1.

38. An electronic device comprising the fuel cell of claim 37.

39. A power supply comprising the fuel cell of claim 37.

40. A vehicle comprising the fuel cell of claim 37.
